(19) United States
(12) Patent Application Publication
(10) Pub. No.: US 2025/0296515 A1
(43) Pub. Date: Sep. 25, 2025

(54) Fastener, Fastening Assembly and Vehicle

(71) Applicant: Illinois Tool Works Inc., Glenview, IL (US)

(72) Inventor: Liang Huang, Shanghai (CN)

(21) Appl. No.: 19/082,712

(22) Filed: Mar. 18, 2025

(30) Foreign Application Priority Data
Mar. 20, 2024 (CN) 202410323736.6
Mar. 13, 2025 (CN) 202510297967.9

(51) Int. Cl. B60R 13/02; F16B 5/06

(52) U.S. Cl. CPC B60R 13/0206; F16B 5/0642

(57) ABSTRACT

The present disclosure relates to a fastener for connecting to a first component. The fastener includes a main body having a first end and a second end that are opposite each other and defining an axis. A head portion is connected to the first end of the main body. At least one wing is connected to the main body and extending toward the head portion. The at least one wing being deflectable toward and away from the axis of the main body. The at least one wing is provided with a first retaining structure and a second retaining structure. The second retaining structure being located between the first retaining structure and the head portion. The fastener has a first assembly state and a second assembly state, and is configured to retain the first component at least partially between the first retaining structure and the second retaining structure in the first assembly state, and to retain the first component at least partially between the second retaining structure and the head portion in the second assembly state.

### RELATED APPLICATIONS

The present application claims the benefit of Chinese Patent Application Nos. 202410323736.6, filed Mar. 20, 2024, and 202510297967.9, filed Mar. 13, 2025, each titled “Fastener and Fastening Connection Assembly,” the contents of which are hereby incorporated by reference.

### TECHNICAL FIELD

The present disclosure relates to a fastener for a vehicle, a fastening assembly comprising the fastener, and a vehicle comprising the fastening assembly.

### BACKGROUND

During vehicle mounting, it is required to connect two components, for example, connect a vehicle body trim panel to a vehicle sheet metal. Fasteners are generally used to connect these components together. In the prior art, the fasteners are typically pre-assembled on the vehicle body trim panel, and when it is necessary to connect the vehicle body trim panel to the vehicle sheet metal, the fasteners are aligned with pre-set holes in the vehicle sheet metal, and the fasteners can be pressed directly into the holes in the vehicle sheet metal to complete the connection and installation of the vehicle body trim panel to the vehicle sheet metal.

### SUMMARY

The present disclosure relates generally to fasteners, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view from the top of a fastener according to the present disclosure.

FIG. 1B is a perspective view from the bottom of the fastener shown in FIG. 1A.

FIG. 1C is a cross-sectional view of the fastener shown in FIG. 1A taken along section line A-A.

FIG. 2A is a perspective view from the top of a first component according to the present disclosure.

FIG. 2B is a cross-sectional view of the first component shown in FIG. 2A taken along section line B-B.

FIG. 3A is a schematic diagram of a fastening assembly according to the present disclosure before pre-assembly.

FIG. 3B is a perspective view of the fastening assembly shown in FIG. 3A in a first assembly state.

FIG. 3C is a cross-sectional view of the fastening assembly shown in FIG. 3B taken along section line C-C.

FIG. 3D is a cross-sectional view of the fastening assembly shown in FIG. 3C taken along section line D-D.

FIG. 4A is a schematic diagram of a fastening assembly according to the present disclosure that is separated from a second component before insertion into the second component.

FIG. 4B is a schematic diagram of the fastening assembly shown in FIG. 4A in a state in which the fastening assembly has been inserted into the second component but has not yet been fastened.

FIG. 4C is a cross-sectional view of the fastening assembly shown in FIG. 4B taken along section line E-E.

FIG. 4D is a perspective view of the fastening assembly shown in FIG. 4A in a state in which the fastening assembly has been inserted into the second component and has been fastened.

FIG. 4E is a cross-sectional view of the fastening assembly shown in FIG. 4D in a state in which the fastening assembly has been inserted into the second component and has been fastened, taken along a section line in the same direction as shown in FIG. 4C.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” “upper,” “lower,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

After long term observation and study, it has been found, in some existing fasteners, in order to achieve the pre-assembly of the fastener with the first component (e.g., a vehicle trim panel) and the final assembly of the first component with the second component (e.g., vehicle sheet metal), the fastener is provided with two separate retaining structures along a shaft thereof, which makes the shaft of the fastener too long to meet the requirement of compact of the vehicle installation space. Furthermore, it has also been found, in the state of pre-assembly, the fastener may rotate relative to the vehicle trim panel, not facilitating the subsequent final assembly.

According to a first aspect of the present disclosure, a fastener for connecting to a first component is provided, the fastener comprises: a main body comprising a first end and a second end that are opposite each other and defining an axis; a head portion connected to the first end of the main body; and at least one wing connected to the main body and extending toward the head portion, the at least one wing being deflectable toward and away from the axis of the main body, wherein the at least one wing is provided with a first retaining structure and a second retaining structure, the second retaining structure being located between the first retaining structure and the head portion; and wherein the fastener has a first assembly state and a second assembly state, and is configured to retain the first component at least partially between the first retaining structure and the second retaining structure in the first assembly state, and to retain the first component at least partially between the second retaining structure and the head portion in the second assembly state.

According to the first aspect of the present disclosure, the fastener further comprises a foot portion connected to the second end of the main body, wherein the second component is retained between the foot portion and the first component in the second assembly state.

According to the first aspect of the present disclosure, the first retaining structure and the second retaining structure are retaining protrusions protruding outwardly from an outer surface of the wing.

According to the first aspect of the present disclosure, the first retaining protrusion comprises a first guide surface and a first retaining surface, the first retaining surface being located between the first guide surface and the second retaining structure in an axial direction of the main body, and the first guide surface extending obliquely toward the second retaining structure away from the axis, and the second retaining protrusion comprises a second guide surface and a second retaining surface, the second retaining surface being located between the second guide surface and the head portion in the axial direction of the main body, and the second guide surface extending obliquely toward the head portion away from the axis.

According to the first aspect of the present disclosure, the at least one wing is connected to the main body at a position near the second end.

According to the first aspect of the present disclosure, the at least one wing comprises two wings disposed on opposite two sides of the axis respectively.

According to the first aspect of the present disclosure, the main body is provided with a wing receiving portion to at least partially receive the at least one wing when the at least one wing is deflected toward the axis.

According to the first aspect of the present disclosure, the fastener further comprises at least one anti-rotation protrusion disposed on the main body and configured to cooperate with the first component when the fastener is in the first assembly state to prevent the fastener from rotating relative to the first component.

According to the first aspect of the present disclosure, in an axial direction of the main body, the at least one anti-rotation protrusion is disposed between the first retaining structure and the second retaining structure.

According to the first aspect of the present disclosure, the at least one anti-rotation protrusion comprises two anti-rotation protrusions disposed on opposite two sides of the main body respectively.

According to a second aspect of the present disclosure, a fastening assembly for fastening to a second component is provided, the fastening assembly comprise the fastener according to first aspect of the present disclosure and a first component, wherein the fastening assembly has a fastened state in which the first component is retained at least partially between the second retaining structure and the head portion, and the second component is retained at least partially between the first retaining structure of the fastener and the first component.

According to the second aspect of the present disclosure, the first component comprises a first component opening shaped to allow insertion of the fastener, the first component opening is provided with at least one anti-rotation groove configured to cooperate with the at least one anti-rotation protrusion.

According to a third aspect of the present disclosure, a vehicle is provided, the vehicle comprises the fastener according to first aspect of the present disclosure or the fastening assembly according to second aspect of the present disclosure.

By providing at least one deflectable wing, which serves as a retaining device and is connected to the main body, and providing two axially arranged retaining structures on each wing, the fastener of the present disclosure can realize the first assembly state of the fastener by using the space between the two retaining structures (i.e. the first component is at least partially retained between the two retaining structures) and can realize the second assembly state of the fastener by using the space between the second retaining structure and the head portion of the fastener (i.e., the first component is at least partially retained between the second retaining structure and the head portion of the fastener). Therefore, the main body of the fastener of the present disclosure can be designed to be smaller in dimension on the axis than two deflectable retaining devices which are independent of each other in the axial direction of the fastener, so that the requirement for a compact axial installation space can be met. Also, even in a compact axial space, the wing used as a retaining device of the present disclosure can also be extended by a sufficient length, so that it is easy to deflect inwardly, which makes it easier to insert the fastener into the first component. Furthermore, since the wing used as a retaining device of the present disclosure is easy to deflect inwardly, the contact area of the second retaining structure provided on the wing with the first component is also relatively large after the wing is deflected back outwardly, so that the fastener can retain the first component more stably in the second assembly state of the fastener.

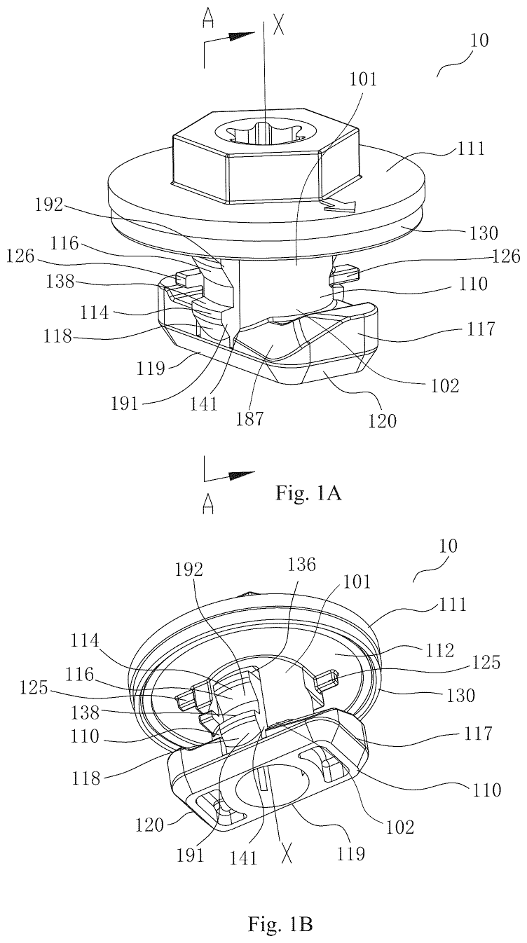

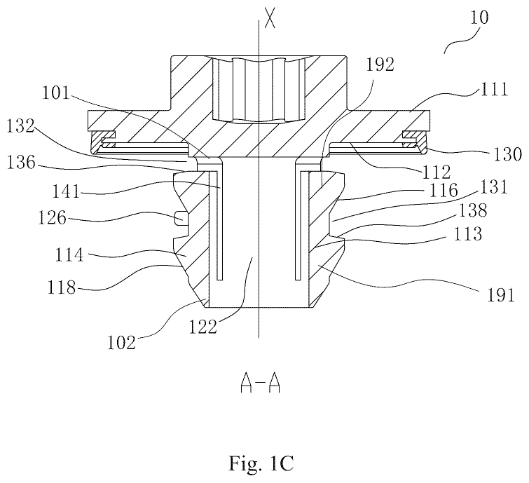

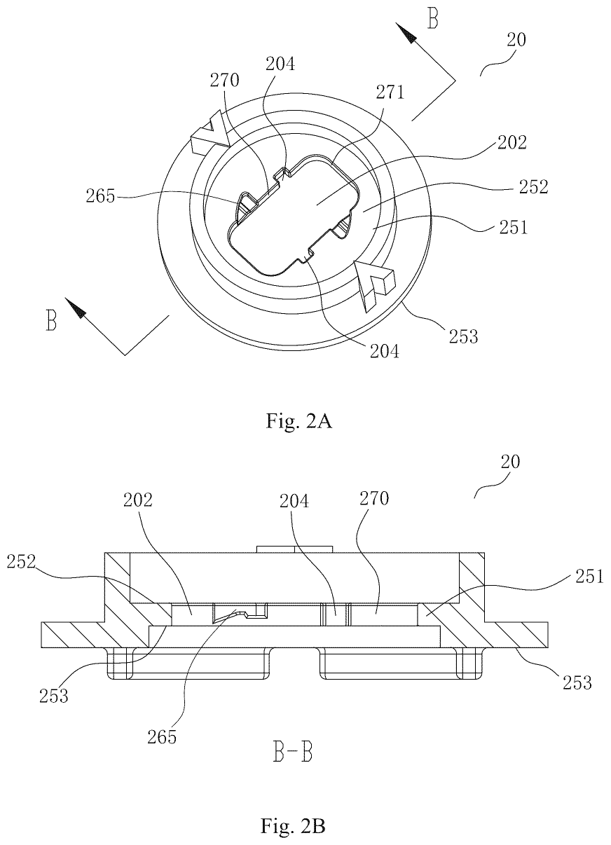

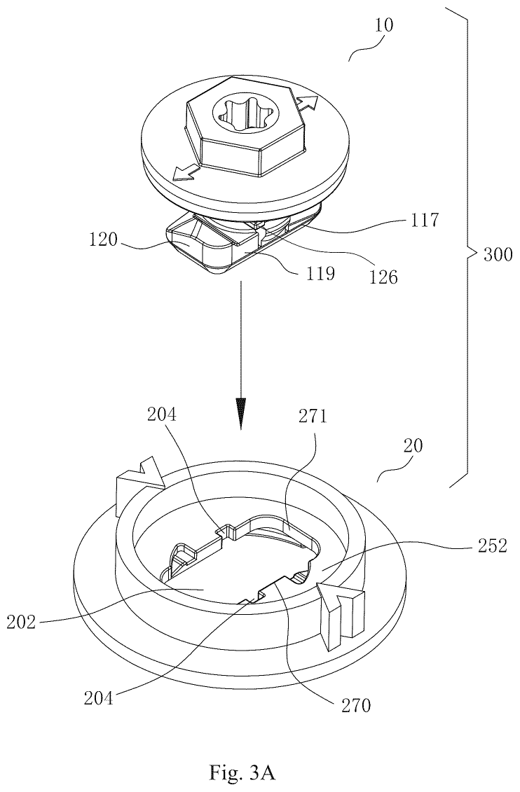

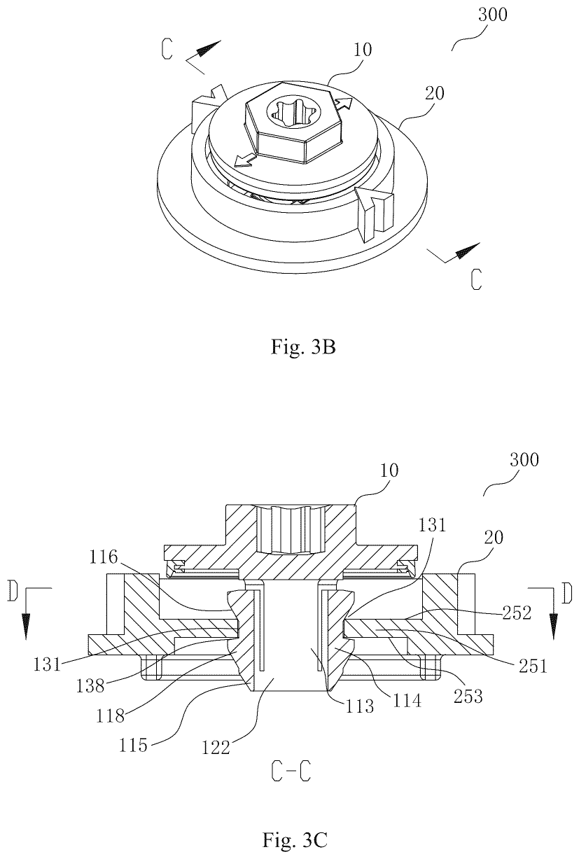

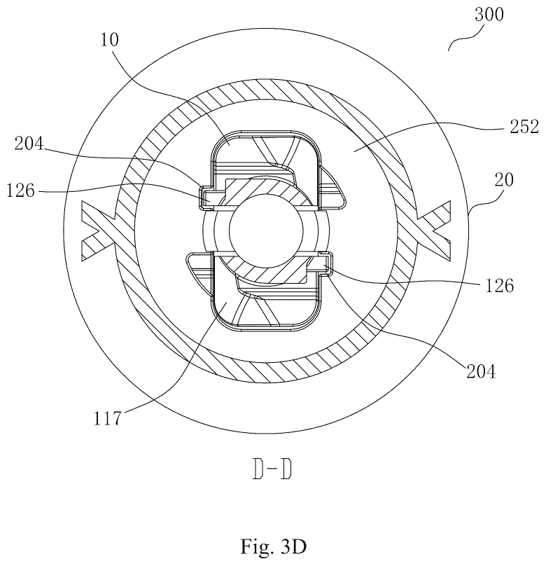

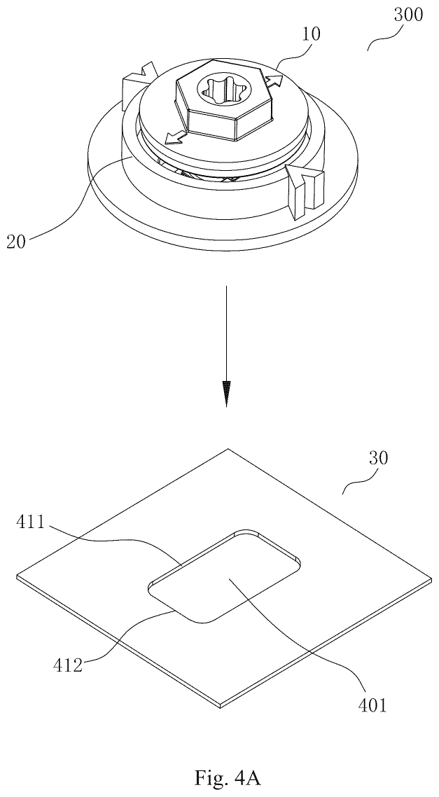

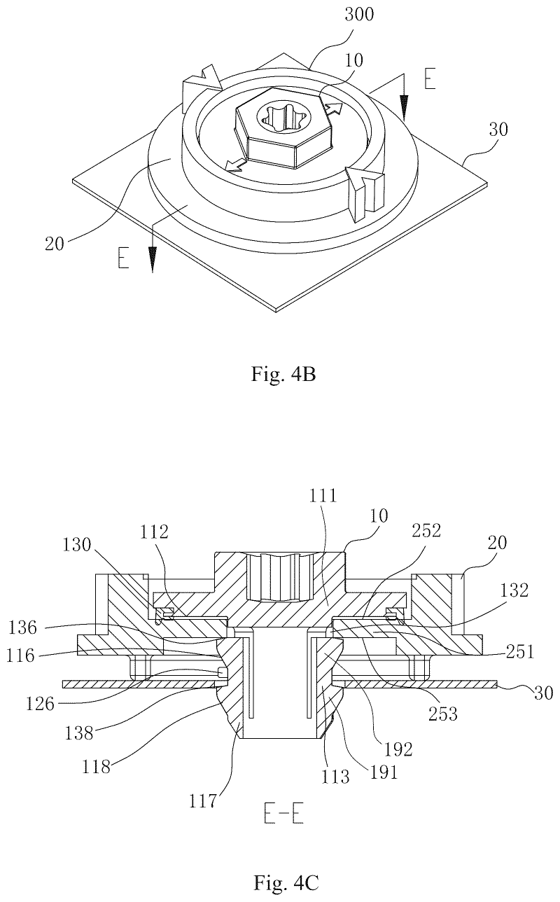

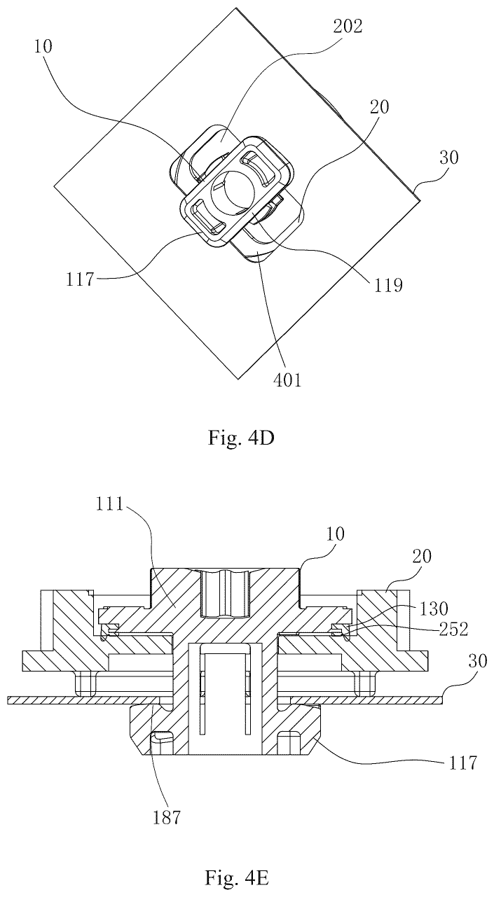

In an embodiment of the present disclosure, a first component 20 (as shown in FIGS. 2A-2B) is connected to a second component 30 (as shown in FIG. 4A) by means of a fastener 10 (as shown in FIGS. 1A-1C). The fastener 10 has two states relative to the first component 20, including a first assembly state and a second assembly state. In the first assembly state, the fastener 10 is inserted into the first component 20, and the fastener 10 and the first component 20 are pre-assembled together. In the second assembly state, the fastener 10 is further inserted into the first component 20 such that a fastening assembly 300 (as shown in FIG. 3A) constituted by the fastener 10 and the first component 20 can be fastened to the second component 30. In the first assembly state (i.e., a pre-assembled state), the fastener 10 does not rotate relative to the first component 20 and also does not easily escape from the first component 20, thereby facilitating the storage, transport, and subsequent final assembly of the first component 20 and the fastener 10 that are pre-assembled together. In the final assembly process in which the fastening assembly 300 constituted by the first component 20 and the fastener 10 is connected to the second component 30, the fastener 10 is further inserted into the first component 20 to reach its second assembly state, such that the fastener 10 can rotate relative to the first component 20, and the first component 20 and the second component 30 can thus be fastened together by means of the fastener 10. In an embodiment, the first component 20 is a plastic vehicle body trim panel, and the second component 30 is a vehicle body metal frame.

FIGS. 1A-1C show a specific structure of a fastener 10 according to the present disclosure. FIG. 1A is a perspective view from the top of a fastener 10. FIG. 1B is a perspective view from the bottom of the fastener shown in FIG. 1A. FIG. 1C is a cross-sectional view of the fastener shown in FIG. 1A taken along section line A-A.

As shown in FIGS. 1A and 1B, the fastener 10 includes a main body 110, a head portion 111 and a foot portion 117. The main body 110 defines an axis X and includes a first end 101 (i.e., an upper end in FIG. 1A) and a second end 102 (i.e., a lower end in FIG. 1A) that are opposite each other, the head portion 111 and the foot portion 117 being connected to the first end 101 and the second end 102 of the main body 110, respectively. The main body 110 is generally rod-shaped.

The head portion 111 may be disk-shaped, and a head portion supporting surface 112 is provided on a side of the head portion 111 facing the main body 110. A seal ring 130 is provided at a position near outer periphery of the head portion supporting surface 112, and the seal ring 130 is supported by a resilient material such as rubber, which may be engaged onto the head portion 111 in a suitable manner, such as by injection molding or bonding.

With continued reference to FIGS. 1A and 1B, the foot portion 117 has a generally rectangular cross-section in a direction transverse to the axis X of the main body, such that the foot portion 117 has a pair of opposing long outer walls 119 and a pair of opposing short outer walls 120. The dimension of the main body 110 in a direction parallel to the long outer wall 119 is less than that of the long outer wall 119 of the foot portion 117.

The fastener 10 also includes at least one wing connected to the main body 110. In an embodiment of the present disclosure, the at least one wing includes two wings 114, the two wings 114 being arranged on opposite sides of the axis X and being arranged approximately symmetrically with respect to the axis X. Each wing 114 is connected to the main body 110 at a position near the second end 102 of the main body 110 and extends toward the head portion 111. The two wings 114 are located on the same side of the main body 110 as the two long walls 119 of the foot portion 117 are located. The two wings 114 are deflectable toward and away from the axis X of the main body 110. Those skilled in the art will appreciate that the two wings 114 may be connected directly to the main body 110 or may be connected to the main body 110 via the foot portion 117.

Each of the two wings 114 includes a first retaining structure 191 and a second retaining structure 192. The first retaining structure 191 and the second retaining structure 192 are arranged in a length direction of the wing 114, the second retaining structure 192 being located between the first retaining structure 191 and the head portion 111. Both the first retaining structure 191 and the second retaining structure 192 are retaining protrusions protruding outwardly from an outer surface of the wing 114. The first retaining structure 191 and the second retaining structure 192 protrude outwardly to the extent that they extend beyond the long outer wall 119 of the head portion 117. The first retaining structure 191 includes a first retaining surface 138 facing the head portion 111 and a first guide surface 118 between the first retaining surface 138 and the foot portion 117. The first retaining surface 138 and the second retaining structure 192 above same together define a first space 131 (i.e., a pre-assembled clamping space) in which the first component is engageable with the fastener 10 so as to be retained between the first retaining structure 191 and the second retaining structure 192, thereby achieving the first assembly state of the fastener 10. The first guide surface 118 extends obliquely away from the axis X toward the second retaining structure 192. The second retaining structure 192 has a second retaining surface 136 facing the head portion 111, and a second guide surface 116 between the second retaining surface 136 and the first retaining structure 191. The second retaining surface 136 and the head portion 111 above same together define a second space 132 in which the first component 20 (see FIG. 2A) engages with the fastener 10 when the fastener 10 is in its second assembly state, and the first component is thus retained between the second retaining structure 192 and the head portion 111.

The main body 113 is provided with a wing receiving portion 141 for receiving the wing at least partially when the wing 114 is deflected toward the axis X. In an embodiment shown in the figures, the wing receiving portion 141 penetrates through the rod-shaped main body 113 in a radial direction so as to receive at least part of the two wings 114. In other embodiments, a wing receiving portion may also be provided on each of opposite sides of the main body 113 for receiving the two wings 114 respectively.

In an embodiment shown in FIGS. 1A-1B, the two wings 114 have upper and lower retaining protrusions that can deflect with the wings 114, the retaining protrusions serving as retaining structures. It should be understood that in other embodiments, the retaining structure may also have other configurations.

With continued reference to FIG. 1A, the main body 113 further includes at least one anti-rotation protrusion 126 disposed between the first retaining structure 191 and the second retaining structure 192, and in an embodiment of the present disclosure, the at least one anti-rotation protrusion 126 includes two anti-rotation protrusions disposed in pairs. When the fastener 10 is in the first assembly state, the anti-rotation protrusion 126 may cooperate with the first component 20 (as shown in FIG. 2A), thereby preventing the rotation of the fastener 10 relative to the first component 20 in the first assembly state. In an embodiment of the present disclosure, the anti-rotation protrusion 126 is a tab extending outwardly from an outer surface of the main body 113, with its extension direction being generally the same as an extension direction of the short outer wall 120 of the foot portion 117, and it will be understood by those skilled in the art that the anti-rotation protrusion 126 may also be provided in the form of other protrusions or have other extension directions.

With continued reference to FIG. 1B, the main body 113 is further provided with a pair of limiting protrusions 125 at a position near the head portion supporting surface 112, the pair of limiting protrusions being symmetrically disposed about the axis X of the main body 113. In the direction of the axis X, each limiting protrusion 125 is located between the second retaining surface 136 of a second retaining structure 192 and the head portion supporting surface 112. Also, the pair of limiting protrusions 125 are located above the pair of short outer walls 120 of the head portion 117 respectively so as to be staggered from the pair of wings 114 in a direction of rotation of the fastener 10, thereby preventing the two from interfering with each other during installation.

With continued reference to FIG. 1A, the upper side of the foot portion 117 of the fastener 10 has a wedge-shaped surface 187 for securing the fastener 10 to the first component 20 (as shown in FIG. 2A) and the second component 30 (as shown in FIG. 4A).

FIG. 1C is a cross-sectional view of the fastener shown in FIG. 1A taken along section line A-A.

As shown in FIG. 1C, the wing 114 is connected to the main body 113 at a position near the second end 102 (lower end) of the main body 113, so that the wing 114 has a sufficient height such that the first guide surface 118 and the second guide surface 116, which may be inclined, can each be provided with a long inclination length, thereby being conducive to guiding the deflection of the wing 114, and making it easier to insert through an opening 202 of the second component 20 (see FIGS. 2A and 2B for details). In addition, the rod-shaped main body 110 has a cavity 122, which forms a wing receiving portion 141.

It should be noted that, although in the illustrated embodiment, the fastener of the present disclosure is provided with two wings, in other embodiments, the fastener of the present disclosure may also be provided with fewer or more wings.

FIGS. 2A-2B show a specific structure of the first component 20 according to the present disclosure. FIG. 2A is a perspective view from the top of the first component 20, and FIG. 2B is a cross-sectional view of the first component 20 taken along section line B-B in FIG. 2A.

As shown in FIGS. 2A and 2B, the first component 20 includes a plate-shaped first component body 251 having a first engagement surface 252 and a second engagement surface 253 opposite each other, and includes a first component opening 202 running through the first component body 251. The first component opening 202 has a substantially rectangular shape that corresponds to the outer contour of the foot portion of the fastener, such that the first component opening 202 has a pair of opposing long inner walls 270 and a pair of opposing short inner walls 271. A length and a width of the first component opening 202 are slightly greater than a length and a width of the foot portion of the fastener respectively, to allow the foot portion of the fastener to be inserted through the first component opening 202. In addition, the first component opening 202 is dimensioned such that when the main body of the fastener is received in the first component opening 202 at a position between the second retaining structure and the head portion, the fastener can rotate in the first component opening 202.

The first component body 251 is provided with two anti-rotation grooves 204, and the two anti-rotation grooves 204 are arranged on the pair of long inner walls 270 of the first component opening 202, respectively, and communicate with the first component opening 202. The anti-rotation groove 204 may receive two anti-rotation protrusions 126 of the fastener (as shown in FIG. 1A), respectively, thereby preventing the fastener from rotating relative to the first component 20. The first engagement surface 252 of the first component 20 is also provided with two recesses 265, which are respectively located on two sides of the first component opening 202, are symmetrical about the center of the first component opening 202, and are in communication with the first component opening 202. The recess 265 is recessed from the first engagement surface 252 toward the second engagement surface 253 by a depth for engaging with a limiting protrusion on the fastener when the fastener secures the first component 20 to the second component, thereby preventing the fastener from rotating and escaping from its fastening position and detaching from these components due to vibrations (such as those generated during the driving of the vehicle).

FIGS. 3A-3D show the process of the fastener 10 entering the first assembly state. FIG. 3A is a schematic diagram of the fastener 10 and the first component 20 before entering the first assembly state, FIG. 3B is a perspective view of the fastener 10 and the first component 20 in the first assembly state, FIG. 3C is a cross-sectional view of the fastening assembly 300 shown in FIG. 3B taken along section line C-C, and FIG. 3D is a cross-sectional view of the fastening assembly 300 shown in FIG. 3C taken along section line D-D.

As shown in FIG. 3A, when it is required to preassembling the fastener 10 to the first component 20, the foot portion 117 of the fastener 10 is aligned with the first component opening 202 such that the long outer wall 119 of the foot portion 117 of the fastener 10 is approximately parallel to the long inner wall 270 of the first component opening 202, and the two anti-rotation protrusions 126 (see FIG. 1A) are generally aligned with the two anti-rotation grooves 204 of the first component 20.

As the foot portion 117 of the fastener 10 is inserted through the first component opening 202, the first guide surfaces 118 (see FIG. 1A) of the first retaining structures 191 of the two wings 114 of the fastener 10 may contact the pair of long inner walls 270 of the first component opening 202, respectively, so that the wings 114 deflect inwardly toward the axis X under the action of the pair of long inner walls 270 of the first component opening 202 until the first retaining structures 191 pass through the first component opening 202 and the fastener 10 reaches the first assembly state and is pre-assembled with the first component 20, as shown in FIGS. 3B-3D.

As shown in FIGS. 3B-3D, in the first assembly state, the first retaining structures 114 of the two wings 114 have passed through the first component opening 202, and the two wings 114 are deflected back outwardly away from the axis X. Thereby, as shown in FIG. 3C, the first component body 251 of the first component 20 is retained in the first space 131 between the first retaining surface 138 of the first retaining structure and the second retaining structure 116, so that the fastener 10 can be prevented from moving relative to the first component 20 in an insertion direction. Meanwhile, as shown in FIG. 3D, the pair of anti-rotation protrusions 126 of the fastener 10 are inserted into the pair of anti-rotation grooves 204 of the first component 20, respectively, so that the fastener 10 cannot rotate relative to the first component 20 in the first assembly state.

FIGS. 4A-4E show the process of inserting the fastening assembly 300 into the second component 30. FIG. 4A shows a schematic diagram of the fastening assembly 300 separated from the second component 30 before insertion into the second component 30, FIG. 4B is a schematic diagram of the fastening assembly 300 shown in FIG. 4A in a state in which the fastening assembly has been inserted into the second component 30 but has not yet been fastened, FIG. 4C is a cross-sectional view of the fastening assembly 300 shown in FIG. 4B taken along section line E-E, FIG. 4D is a perspective view of the fastening assembly 300 shown in FIG. 4A in a state in which the fastening assembly has been inserted into the second component and has been fastened, and FIG. 4E is a cross-sectional view of the fastening assembly 300 shown in FIG. 4D taken along the same section line as in FIG. 4C.

As shown in FIG. 4A, the second component 30 is generally plate-shaped and includes a second component opening 401 for receiving the fastening assembly 300. The second component opening 401 has the same generally rectangular shape as the first component opening 202 (as shown in FIG. 3A). The second component opening 401 has a pair of long sides 411 and a pair of short sides 412, and a length of the pair of long sides 411 and a length of the pair of short sides 412 are respectively greater than dimensions of the foot portion of the fastener 10 in length and width directions, such that the foot portion of the fastener 10 can be inserted through the second component opening 401. However, the length of the pair of short sides 412 of the second component opening 401 is less than the dimension of the foot portion of the fastener 10 in the length direction, such that the foot portion of the fastener 10 cannot be escaped from the second component opening 401 when the length of the foot portion of the fastener 10 spans across the width of the second component opening 401. The second component 30 is typically a stationary component, such as a sheet metal part of a vehicle.

When the pre-assembled fastening assembly 300 in FIG. 4A is inserted into the second component opening 401, firstly making the long outer wall 119 and the short outer wall 120 of the foot portion 117 of the fastener 10 parallel to the long side 411 and the short side 412, respectively, of the second component opening 401, and then inserting the foot portion 117 of the fastener 10 into the second component opening 401. As the fastener 10 continues to be inserted into the second component opening 401, the bottom of the first component 20 contacts and abuts against the second component 30 such that the fastener 10 can move axially relative to the first component 20, and the second guide surfaces 116 of the second retaining structures 192 of the two wings 114 of the fastener 10 can abut against the pair of long inner walls 270 of the first component opening 202, respectively, so that the two wings 114 are deflected inwardly again toward the axis X under the action of the pair of long inner walls 270 of the first component opening 202, until the second retaining structures 192 pass through the first component opening 202 to the state shown in FIGS. 4B-4C.

As shown in FIGS. 4B-4C, the fastener 10 reaches its second assembly state, and the first component 20 is retained at least partially between the second retaining structures 192 and the head portion 111 of the fastener 10. At this time, the foot portion 117 of the fastener 10 has also passed through the second component opening 401 of the second component 30, but the fastener 10 has not yet fastened the first component 20 to the second component 30. Furthermore, since the anti-rotation protrusion of the fastener 10 has disengaged from the anti-rotation groove on the first component 20, the fastener 10 can rotate relative to the first component 20 and the second component 30.

As shown in FIGS. 4D-4E, when the fastener 10 in the state shown in FIGS. 4B-4C is rotated in a predetermined direction (e.g., a clockwise direction) relative to the first component 20 and the second component 30, the foot portion 117 of the fastener 10 gradually transitions to a state of being transverse to the second component opening 401 of the second component 30 (as shown in FIG. 4D), and the wedge-shaped surface 187 on the fastener 10 may gradually press the first component 20, the second component 30 and the head portion 111 of the fastener 10 together by the inclined characteristic of the wedge-shaped surface, thereby achieving a fastening connection of the fastener 10 to the first component 20 and the second component 30.

The present disclosure further sets forth a vehicle, including the fastener, the first component and the second component described above. In an embodiment, the first component is a plastic vehicle body trim panel, and the second component is a vehicle body metal frame or a vehicle sheet metal part.

By providing at least one deflectable wing, which serves as a retaining device and is connected to the main body, and providing two axially arranged retaining structures (two-stage retaining structure) on each wing, the fastener of the present disclosure can realize the first assembly state of the fastener by using the space between the two retaining structures (i.e. the first component is at least partially retained between the two retaining structures) and can realize the second assembly state of the fastener by using the space between the second retaining structure and the head portion of the fastener (i.e., the first component is at least partially retained between the second retaining structure and the head portion of the fastener). Therefore, the main body of the fastener of the present disclosure can be designed to be smaller in dimension on the axis than two deflectable retaining devices independently disposed in the axial direction of the fastener, so that the requirement for a compact axial installation space can be met. Also, even in a compact axial space, the wing used as a retaining device of the present disclosure can also be extended by a sufficient length, so that it is easy to deflect inwardly, which makes it easier to insert the fastener into the first component. Furthermore, since the wing used as a retaining device of the present disclosure is easy to deflect inwardly, the contact area of the second retaining structure provided on the wing with the first component is also relatively large after the wing is deflected back outwardly, so that the fastener can retain the first component more stably in the second assembly state of the fastener.

Furthermore, by providing an anti-rotation protrusion, which is provided on the main body of the fastener and independent of the deflectable wing such that when the fastener is in the pre-assembled position relative to the first component, the anti-rotation protrusion cooperates with the anti-rotation groove on the first component, it may prevent the fastener of the present disclosure from rotating relative to the first component, and the anti-rotation function is also not influenced by the deflection of the wing, thereby more firmly retaining the fastener and the first component together when they are in the pre-assembled state, so that they will not easy to separate from each other by force during storage and transport.

Although the present disclosure is described with reference to the examples of the embodiments outlined above, various alternatives, modifications, variations, improvements and/or substantial equivalents, which are known or can be anticipated at present or to be anticipated before long, may be obvious to those of at least ordinary skill in the art. In addition, the technical effects and/or technical problems described in this specification are exemplary rather than limiting. Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

Description of main reference signs

| | | | |
|---|---|---|---|
| Axis of main body | X | Fastener | 10 |
| First component | 20 | Second component | 30 |
| First end | 101 | Second end | 102 |
| Main body | 110 | Head portion | 111 |
| Head portion supporting | 112 | Main body | 113 |
| surface | | | |
| Wing | 114 | Second guide surface | 116 |
| Foot portion | 117 | First guide surface | 118 |
| Long outer wall | 119 | Short outer wall | 120 |
| Cavity | 122 | Limiting protrusion | 125 |
| Anti-rotation protrusion | 126 | Seal ring | 130 |
| First space | 131 | Second space | 132 |
| Second retaining surface | 136 | First retaining surface | 138 |
| Wing receiving portion | 141 | Wedge-shaped surface | 187 |
| First retaining structure | 191 | Second retaining structure | 192 |
| First component opening | 202 | Anti-rotation groove | 204 |
| First component body | 251 | First engagement surface | 252 |
| Second engagement surface | 253 | Recess | 265 |
| Long inner wall | 270 | Short inner wall | 271 |
| Fastening assembly | 300 | Second component opening | 401 |
| Long side | 411 | Short side | 412 |

What is claimed is:

1. A fastener for connecting a first component relative to a second component, comprising:
a main body, comprising a first end and a second end that are opposite each other and defining an axis;
a head portion connected to the first end of the main body; and
at least one wing connected to the main body and extending toward the head portion, the at least one wing being deflectable toward and away from the axis of the main body;
wherein the at least one wing is provided with a first retaining structure and a second retaining structure, the second retaining structure being located between the first retaining structure and the head portion; and
wherein the fastener has a first assembly state and a second assembly state, and is configured to retain the first component at least partially between the first retaining structure and the second retaining structure in the first assembly state, and to retain the first component at least partially between the second retaining structure and the head portion in the second assembly state.

2. The fastener according to claim 1, further comprising:
a foot portion connected to the second end of the main body, wherein the second component is retained between the foot portion and the first component in the second assembly state.

3. The fastener according to claim 1, wherein
the first retaining structure and the second retaining structure are retaining protrusions protruding outwardly from an outer surface of the wing.

4. The fastener according to claim 3, wherein
the first retaining protrusion comprises a first guide surface and a first retaining surface, the first retaining surface being located between the first guide surface and the second retaining structure in an axial direction of the main body, and the first guide surface extending obliquely toward the second retaining structure away from the axis; and
the second retaining protrusion comprises a second guide surface and a second retaining surface, the second retaining surface being located between the second guide surface and the head portion in the axial direction of the main body, and the second guide surface extending obliquely toward the head portion away from the axis.

5. The fastener according to claim 1, wherein
the at least one wing is connected to the main body at a position near the second end.

6. The fastener according to claim 1, wherein
the at least one wing comprises two wings which are disposed on opposite two sides of the axis, respectively.

7. The fastener according to claim 1, wherein
the main body is provided with a wing receiving portion to at least partially receive the at least one wing when the at least one wing is deflected toward the axis.

8. The fastener according to claim 1, further comprising:
at least one anti-rotation protrusion disposed on the main body and configured to cooperate with the first component when the fastener is in the first assembly state to prevent the fastener from rotating relative to the first component.

9. The fastener according to claim 8, wherein
in an axial direction of the main body, the at least one anti-rotation protrusion is disposed between the first retaining structure and the second retaining structure.

10. The fastener according to claim 9, wherein
the at least one anti-rotation protrusion comprises two anti-rotation protrusions disposed on opposite two sides of the main body, respectively.

11. A fastening assembly for fastening to a second component, the fastening assembly comprising:
the fastener according to claim 8; and
a first component;
wherein the fastening assembly has a fastened state in which the first component is retained at least partially between the second retaining structure and the head portion, and the second component is retained at least partially between the first retaining structure of the fastener and the first component.

12. The fastening assembly according to claim 11, the first component comprises:
a first component opening shaped to allow insertion of the fastener, the first component opening being provided with at least one anti-rotation groove configured to cooperate with the at least one anti-rotation protrusion.

13. A vehicle, comprising the fastener of claim 1.
